(19) United States
(12) Patent Application Publication
(10) Pub. No.: US 2016/0203887 A1
(43) Pub. Date: Jul. 14, 2016

(54) SHIELDED ELECTRICAL CABLE

(71) Applicant: Electro-Motive Diesel, Inc., LaGrange, IL (US)

(72) Inventor: James F. Wiemeyer, Homer Glen, IL (US)

(73) Assignee: Electro-Motive Diesel, Inc., LaGrange, IL (US)

(21) Appl. No.: 15/079,323

(22) Filed: Mar. 24, 2016

(51) Int. Cl. H01B 11/18; H01B 7/02

(52) U.S. Cl. CPC H01B 11/1895; H01B 7/0208

(57) ABSTRACT

A cable for transmitting electrical signals is provided. The cable includes an elongated conducting core, a conducting shield layer disposed around the conducting core, and a capacitor electrically coupled with the conducting shield layer. The capacitor includes a hollow insulating body that receives the conducting core therethrough. The cylinder includes a circuit disposed around an outer surface of the hollow insulating body. The circuit includes a first conductive plate, a second conductive plate, and a dielectric material sheet disposed between the first conductive plate and the second conductive plate. The circuit is adapted to selectively allow flow of electric current therethrough based on a frequency of electrical and electromagnetic radiations.

### TECHNICAL FIELD

The present disclosure relates to electrical cables, and more particularly to a shielded electrical cable for transmitting electrical signals between electrical devices.

### BACKGROUND

Shielded electrical cables are used for transmission of electrical signals between appliances, such as computers, controllers, and electronic actuators. Often, the shielded electrical cables are employed in an environment having electrical and electromagnetic radiations. The electrical and electromagnetic radiations may affect the electrical signals transmitted by a shielded electrical cable. Typically, a shielded electrical cable includes one or more insulated core conductors for carrying the electrical signals. The insulated core conductors are enclosed by one or more layers of a conducting shield. The conducting shield reduces electrical and electromagnetic interference between the electrical signals transmitted by the core conductors and the electrical and electromagnetic radiation. Further, a plastic jacket encloses the conducting shield for insulation of the shielded cable.

In some configurations where high frequency electrical and electromagnetic radiations are present, and in order to avoid high frequency aggressor electrical and electromagnetic radiations from adversely affecting the electrical signals, the conducting shield is grounded at both ends. Further, in some configurations, low frequency aggressor electrical and electromagnetic radiations are present, and in order to avoid low frequency aggressor electrical and electromagnetic radiation from adversely affecting the electrical signals, the conducting shield is grounded at only one end. However, in systems with conventional electrical cables, both the configurations of grounding the conducting shield are mutually exclusive. Therefore, it becomes difficult to avoid both high frequency aggressor electrical and electromagnetic radiations and low frequency aggressor electrical and electromagnetic radiations from adversely affecting the electrical signals, at the same time.

U.S. Pat. No. 8,963,015, hereinafter referred to as '015 patent, discloses a capacitor coupled cable shield feedthrough. In the '015 patent, shielding performance and protection from radiated radio frequency energy at a cable's point of entry to an enclosure are obtained when a shield of the cable is coupled around an entire opening of the enclosure using a disc shaped capacitor. The capacitor may be electrically coupled to the shield and the enclosure around the entire inner and outer circumferences of the disc shaped capacitor. The disc shaped capacitor lowers inductance and improves shielding of the opening itself while improving filtering characteristics and preventing ground loops. However, the capacitor as described in the '015 patent has limited applicability with respect to different sizes and shapes of the cables. Moreover, a modification in design of the enclosure may be required in order to connect the capacitor coupled cable shield feedthrough with the enclosure.

### SUMMARY OF THE DISCLOSURE

In one aspect of the present disclosure, a cable for transmitting electrical signals is provided. The cable includes an elongated conducting core adapted to transmit electrical signals. The cable also includes a conducting shield layer disposed around the elongated conducting core. The conducting shield layer has a first end and a second end. The first end is adapted to be electrically coupled with a first frame of a first electrical device. The second end is adapted to be electrically coupled with a second frame of a second electrical device. The cable further includes a capacitor electrically coupled with the conducting shield layer. The capacitor includes a hollow insulating body having an inner surface and an outer surface. The hollow insulating body receives the conducting core. The capacitor also includes a circuit disposed around the outer surface of the hollow insulating body. The circuit includes a first conductive plate, a second conductive plate, and a dielectric material sheet disposed between the first conductive plate and the second conductive plate. The circuit selectively allows flow of electric current therethrough based on a frequency of electrical and electromagnetic radiations. Further, the at least one of the first conductive plate and the second conductive plate is electrically coupled to the conducting shield layer.

Other features and aspects of this disclosure will be apparent from the following description and the accompanying drawings.

### BRIEF DESCRIPTION OF THE DRAWINGS

FIG. 1 is a diagrammatic view of a cable connected to a first electrical device and a second electrical device, according to one concept of the present disclosure;

FIG. 2 is a fragmented side view of the cable coupled to a first frame of the first electrical device;

FIG. 3 is an exploded view of a capacitor of the cable;

FIG. 4 is a sectional view of a circuit of the capacitor taken along a line A-A′ of FIG. 3; and

FIG. 5 is a planar view of a circuit of the capacitor, according to another concept of the present disclosure.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

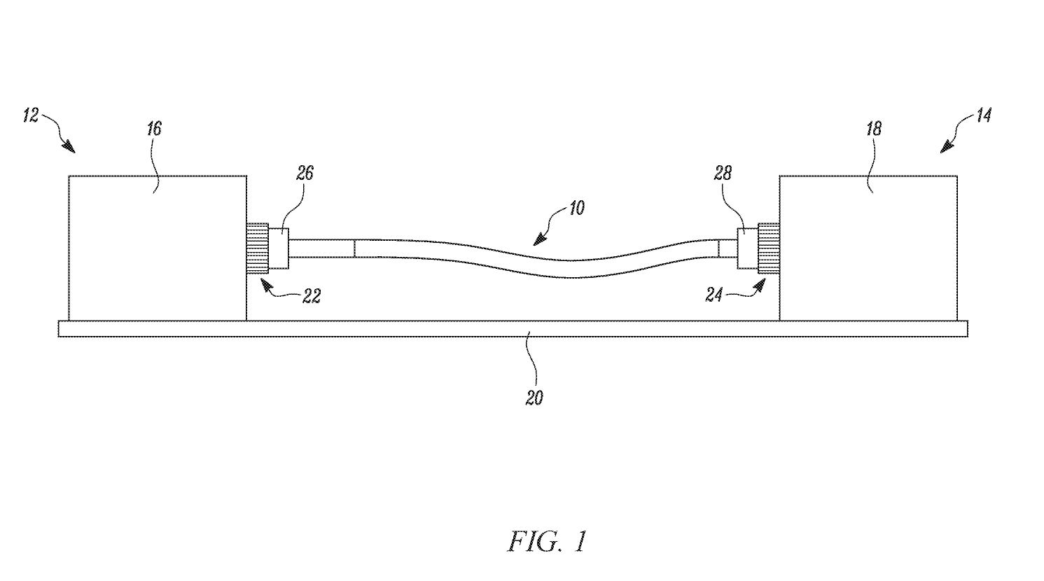

FIG. 1 is a diagrammatic view of a cable 10 connected to a first electrical device 12 and a second electrical device 14 at ends thereof, according to one concept of the present disclosure. The cable 10 is adapted to transmit electrical signals between the first electrical device 12 and the second electrical device 14. In one example, the first electrical device 12 and the second electrical device 14 are an electrical signal generator and an electrical signal receiver, respectively. Alternatively, the first electrical device 12 may be the electrical signal receiver and the second electrical device 14 may be the electrical signal generator.

The first electrical device 12 includes a first frame 16 and a first circuit (not shown) adapted to generate electric signals and enclosed within the first frame 16. The second electrical device 14 includes a second frame 18 and a second circuit (not shown) adapted to receive the electrical signals and enclosed within the second frame 18. Examples of the first electrical device 12 include, but are not limited to, a function generator, a video signal generator, a pitch and audio generator, an electric transducer, and a radio frequency and microwave signal generator. Examples of the second electrical device 14 include, but are not limited to, an antenna, a controller, an amplifier, a translator, and a signal filter. Further, both the first frame 16 and the second frame 18 are supported on a ground surface 20. The first frame 16 and the second frame 18 are electrically grounded at different locations on the ground surface 20. Since the first frame 16 and the second frame 18 are electrically grounded at different locations on the ground surface 20, a potential difference is obtained between the first frame 16 and the second frame 18.

Further, the cable 10 is connected to the first electrical device 12 and the second electrical device 14, via a first connector 22 and a second connector 24, respectively. The first connector 22 and the second connector 24 are adapted to conductively couple the cable 10 with the first electrical device 12 and the second electrical device 14. The first connector 22 includes a first connecting plug (not shown) that facilitates electrical communication between the cable 10 and the first electric circuit of the first electrical device 12. The first connector 22 also includes a first connector shell 26 conductively coupled to the first frame 16. The first connector shell 26 encloses the first connecting plug therein. Further, the second connector 24 includes a second connecting plug (not shown) that facilitates electrical communication between the cable 10 and the second electric circuit of the second electrical device 14. The second connector 24 also includes a second connector shell 28 conductively coupled to the second frame 18. The second connector shell 28 encloses the first connecting plug therein.

While the first electrical device 12 and the second electrical device 14 are described as the electrical signal generator and the electrical signal receiver, respectively, it will be appreciated that configurations, constructions and application of both the first electrical device 12 and the second electrical device 14 are not limited to those described above. Specifically, the cable 10 may be used to transmit electrical signals in various applications, such as computer network connections, telecommunication network connections, and interconnected signaling systems. In such applications, the cable 10 may be subjected to electrical and electromagnetic radiations, hereinafter interchangeably referred to as Electrical and Electromagnetic Interference (EMI) radiations. The EMI radiations may be generated by one or more electrical and electronics instruments and other cables surrounding the cable 10.

Further, a first pre-defined frequency “F1” and a second pre-defined frequency “F2” may be defined within an electromagnetic spectrum of the EMI radiations. The first pre-defined frequency “F1” and the second pre-defined frequency “F2” may be defined based on an application and merit of the cable 10. In one example, the first pre-defined frequency “F1” is 10 kHz and the second pre-defined frequency “F2” is 100 kHz. The cable 10 of the present disclosure is adapted to transmit electrical signals while limiting electromagnetic interferences between the electrical signals, and EMI radiations based on the first pre-defined frequency “F1” and the second pre-defined frequency “F2”. The cable 10 also limits electromagnetic interferences caused due to the potential difference between the first frame 16 and the second frame 18.

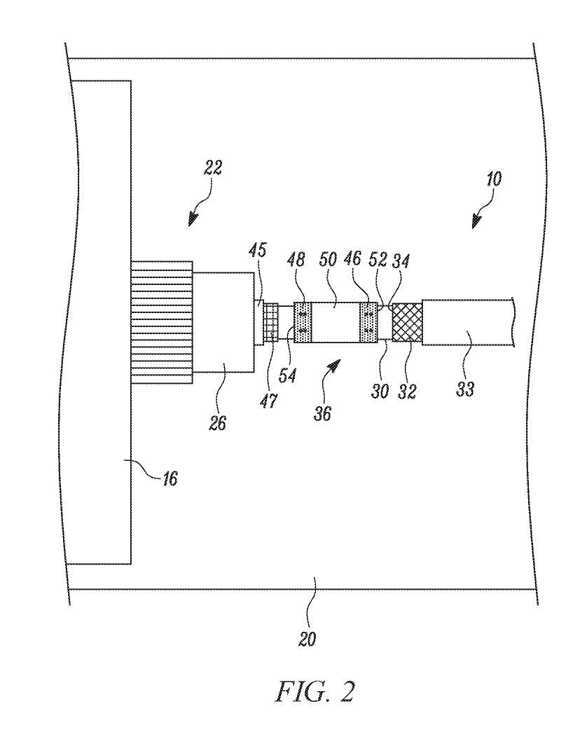

FIG. 2 is a fragmented side view of the cable 10 coupled to the first frame 16 of the first electrical device 12. The cable 10 includes an elongated conducting core 30. The elongated conducting core 30 is connected to both the first connecting plug and the second connecting plug of the first and second electrical devices 12, 14. The elongated conducting core 30 is adapted to transmit electrical signals between the first electrical device 12 and the second electrical device 14. In one example, the elongated conducting core 30 may be made of an electrical conductor made of materials, such as copper, tin, aluminum, conducting alloys, conducting polymers or combinations thereof. In another example, the elongated conducting core 30 includes multiple electrical conductors bundled together, in such a case, each electrical conductor may be individually insulated from each other in order to provide the cable 10 with multiple electrical paths to transmit the electrical signals. Further, an electrically insulating binding tape (not shown) may also be wrapped around the electrical conductors to bind the electrical conductors into a unitary cylindrical unit.

The cable 10 also includes a conducting shield layer 32 disposed around the elongated conducting core 30. In one example, an insulating jacket 33 is wrapped around the conducting shield layer 32 to provide insulation to the conducting shield layer 32 from ambient, such as the ground surface 20 and other cables (not shown). In one example, the conducting shield layer 32 is electrically insulated from the elongated conducting core 30 by means of the electrically insulating binding tape. The conducting shield layer 32 provides electric path to induced electric currents. Such induced electric currents may be generated due to the EMI radiations and the potential difference between the first frame 16 and the second frame 18. In one example, the conducting shield layer 32 is made of braided strands of conducting materials, such as copper, tin, aluminum, conducting alloys, conducting polymers or combination thereof. In another example, the conducting shield layer 32 may be formed by a foil made of conducting materials.

The conducting shield layer 32 has a first end 34 and a second end (not shown). The second end is electrically coupled with the second connector shell 28 of the second frame 18. In various examples, a drain wire (not shown) may also be used to connect the conducting shield layer 32 with the second connector shell 28 of the second frame 18. Thus, the second end of the conducting shield layer 32 is grounded. As shown in FIG. 2, the cable 10 also includes a capacitor 36 electrically coupled with the first end 34 of the conducting shield layer 32 and the second connector shell 28. Both the capacitor 36 and the conducting shield layer 32 provide electric path to induced electric currents generated due to the EMI radiations, and the potential difference between the first frame 16 and the second frame 18. The induced electric currents are transmitted between the first frame 16 and the second frame 18, via the capacitor 36 and the conducting shield layer 32 based on a frequency of the EMI radiations and based on a frequency of the potential difference between the first frame 16 and the second frame 18. More specifically, both the capacitor 36 and the conducting shield layer 32 allow flow of induced electric currents generated due to the EMI radiations therethrough when a frequency of the EMI radiations is equal to or greater than the second predefined frequency “F2”. Further, both the capacitor 36 and the conducting shield layer 32 constrain flow of induced electric currents generated due to the potential difference based on a frequency of the potential difference. Furthermore, the conducting shield layer 32 also provides a high frequency return path to the electrical signals transmitted by the elongated conducting core 30.

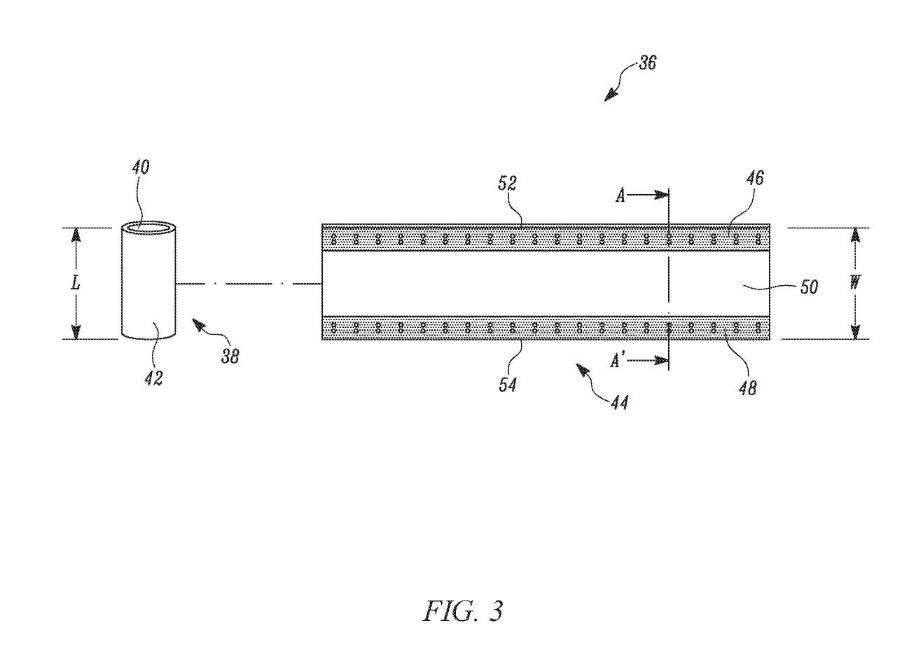

FIG. 3 is an exploded view of the capacitor 36. The capacitor 36 includes a hollow insulating body 38. The hollow insulating body 38 is cylindrical in shape. The hollow insulating body 38 has an inner surface 40 and an outer surface 42. The hollow insulating body 38 has a first length ‘L’. The capacitor 36 further includes a circuit 44. The circuit 44 has a width ‘W’ equal to the first length ‘L’ of the hollow insulating body 38. The circuit 44 can be wrapped around the hollow insulating body 38 to form the capacitor 36.

During assembly of the cable 10, the hollow insulating body 38 receives the elongated conducting core 30 such that the hollow insulating body 38 is coaxially aligned with the elongated conducting core 30. Further, the circuit 44 is disposed around the outer surface 42 of the hollow insulating body 38. In one example, the circuit 44 is coupled to the outer surface 42 of the hollow insulating body 38 by means of adhesives. Further, the capacitor 36 may be assembled with the elongated conducting core 30, the first connector shell 26, and the conducting shield layer 32 by a shrink tubing process. In the shrink tubing process, one or more coverings 45 having an inner conducting layer (not shown) are disposed around the capacitor 36 and a connector flange 45 of the first connector shell 26. The inner conducting layer (not shown) facilitates electric communication between the circuit 44 of the capacitor 36 and the first connector flange 45 of the first connector shell 26. In various other examples, the circuit 44 may also be electrically connected with the first connector shell 26 by means of at least one of a multiple crimp ferrules, a soldering process and a conducting tape.

Referring to FIGS. 2 and 3, the circuit 44 is connected to the first end 34 of the conducting shield layer 32. The circuit 44 is also connected to the first connector shell 26. In various examples, the circuit 44 may be electrically coupled with the conducting shield layer 32 and the first connector shell 26 by various methods, such as the soldering process, shrink tubing process, crimping process or a combination thereof. The circuit 44 selectively allows flow of induced electric current therethorugh based on a frequency of the EMI radiations. More specifically, the circuit 44 allows transmission of electric currents therethrough if the frequency of the EMI radiations is above the second pre-defined frequency “F2”. Further, the circuit 44 constrains transmission of electric current therethrough if the frequency of the EMI radiations is below the second pre-defined frequency “F2”.

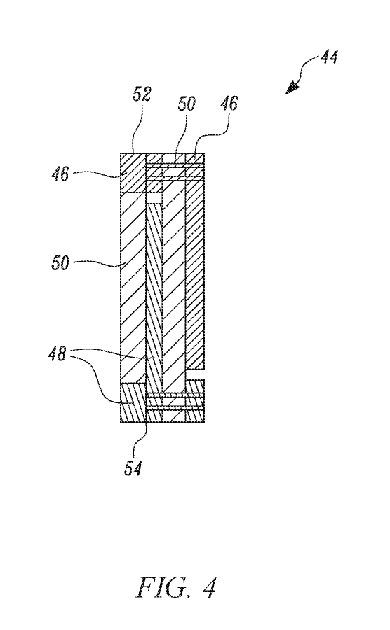

FIG. 4 is a sectional view of the circuit 44 of the cable 10 taken along a line A-A′ in FIG. 3. The circuit 44 includes a first conductive plate 46, a second conductive plate 48, and a dielectric material sheet 50 disposed between the first conductive plate 46 and the second conductive plate 48. The first conductive plate 46 and the second conductive plate 48 are made of copper. In various examples, the first conductive plate 46 and the second conductive plate 48 may be made of other conducting materials, such as tin, aluminum, polymer, and alloys. In one example, the dielectric material sheet 50 is made of polyamides. However, in various examples, the dielectric material sheet 50 may be made of material that may include, but is not limited to, mica, nylon, silicone, and glass. It is understood that the first conductive plate 46, the second conductive plate 48, and the dielectric material sheet 50 may also be made of resilient conducting materials such that the circuit 44 can be wrapped around the hollow insulating body 38.

The first conductive plate 46 and the second conductive plate 48 extend along a first lateral end 52 and a second lateral end 54, respectively, of the circuit 44. The first conductive plate 46 and the second conductive plate 48 also extend between the first lateral end 52 and the second lateral end 54 such that the dielectric material sheet 50 is positioned between the first conductive plate 46 and the second conductive plate 48.

Referring to FIGS. 2 to 4, the first conductive plate 46 and the second conductive plate 48 are coupled with the conducting shield layer 32 and the first connector shell 26, respectively. Therefore, the induced electric currents flow is allowed between the conducting shield layer 32 and the first connector shell 26. In one example, the first conductive plate 46 and the second conductive plate 48 are coupled with the conducting shield layer 32 and the first connector shell 26, respectively. Alternatively, a pair of crimp ferrules (not shown) may also be provided at first and second lateral ends 52, 54 of the circuit 44 to connect the circuit 44 with the conducting shield layer 32 and the first connector shell 26. The first conductive plate 46 and the second conductive plate 48 act as a pair of power electrodes. In particular, the first conductive plate 46 is configured as a power supply electrode while the second conductive plate 48 is configured as a power receiver electrode. Alternatively, the first conductive plate 46 may be configured as the power receiver electrode whereas the second conductive plate 48 may be configured as the power supply electrode.

When the frequency of the EMI radiations is above the second pre-defined frequency “F2”, the dielectric material sheet 50 gets ionized to allow flow of induced electric currents between the first conductive plate 46 and the second conductive plate 48, thereby allowing induced electric current flow through the conducting shield layer 32. As such, a low impedance of the capacitor 36 is obtained to conduct induced electric currents through the conducting shield layer 32 and the capacitor 36. In turn, the flow of induced current opposes the EMI radiations by generating counter electromagnetic radiations which substantially reduces electromagnetic interferences between the EMI radiations and the electrical signals transmitted by the elongated conducting core 30.

When the frequency of the EMI radiations is below the first pre-defined frequency “F1”, the induced electric currents generated due to the EMI radiations distorts the electrical signals transmitted by the elongated conducting core 30. In such cases, the circuit 44 impedes the transmission of the induced electric currents generated due to the potential difference between the first frame 16 and the second frame 18. In particular, the dielectric material sheet 50 gets ionized to substantially constrain the transmission of the induced electric current through the conducting shield layer 32. As such, a high impedance of the capacitor 36 is obtained to constrain flow of induced electric currents through the conducting shield layer 32 and the capacitor 36. Thus, electromagnetic interference between the electrical signals and the EMI radiations at frequencies below the first pre-defined frequency “F1” is substantially reduced. Further, the capacitor 36 transitions between the low impedance and the high impedance in a transition frequency band defined between the first pre-defined frequency “F1” and the second pre-defined frequency “F2” of the EMI radiations.

The capacitor 36 also constrains flow of induced electric currents generated due to the potential difference based on a frequency of the potential difference. The induced currents generated below a threshold frequency distort the electrical signals transmitted by the elongated conducting core 30. In such cases, the circuit 44 impedes such induced electrical currents, thereby reducing electromagnetic interference to the electrical signals transmitted by the elongated conducting core 30.

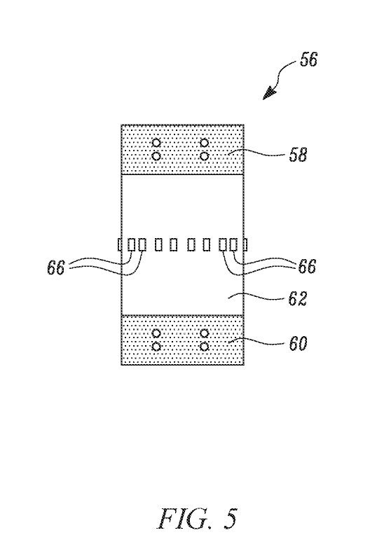

FIG. 5 is a planar view of a circuit 56 of the capacitor 36, according to another embodiment of the present disclosure. Similar to the circuit 44 of FIG. 4, the circuit 56 is adapted to be disposed around the outer surface 42 of the hollow insulating body 38. The circuit 56 also includes a first conductive plate 58, a second conductive plate 60, and a dielectric material sheet 62 extending between the first conductive plate 58 and the second conductive plate 60. In addition, the circuit 56 includes a plurality of surface mounted capacitor units 66 mounted on the dielectric material sheet 62. The surface mounted capacitor units 66 are tangentially disposed on the dielectric material sheet 62. In one example, the surface mounted capacitor units 66 are coupled to the dielectric material sheet 62 by means of multiple plated-through holes (not shown) of the dielectric material sheet 62. The surface mounted capacitor units 66 are also electrically connected to the first conductive plate 58 and the second conductive plate 60. Specifically, the first conductive plate 58, the second conductive plate 60, the dielectric material sheet 62, and the surface mounted capacitor units 66 together selectively allow flow of electric current through the capacitor 36 based on a frequency of the EMI radiations.

Although, in the illustrated example, the capacitor 36 is shown to be connected between the first end 34 of the conducting shield layer 32 and the first connector shell 26, it may be contemplated that the capacitor 36 can also be coupled with the conducting shield layer 32 at any intermediate location within the conducting shield layer 32. Moreover, the circuits 44, 56 may be coupled with the outer surface 42 of the hollow insulating body 38 by various coupling methods such as crimping and adhesives. However, in another example, the circuits 44, 56 may also be directly printed on the hollow insulating body 38. In yet another example, the circuits 44, 56 may include multiple first conducting plates (not shown) and multiple second conducting plates (not shown) interdigitated together such that a dielectric material sheet (not shown) is disposed between each first conducting plate and each second conducting plate. Further, it is understood that the first conducting plates and the second conducting plates may be arranged in any manner such that the dielectric material sheet is disposed between each first conducting plate and each second conducting plate.

### INDUSTRIAL APPLICABILITY

The present disclosure relates to the cable 10 for transmitting electrical signals. The cable 10 transmits electrical signals between the first electrical device 12 and the second electrical device 14. The elongated conducting core 30 of the cable 10 is electrically coupled with the first connecting plug and the second connecting plug to transmit electrical signals between the first electrical device 12 and the second electrical device 14.

The second end of the conducting shield layer 32 is connected to the second connector shell 28 of the second connector 24, and the first end 34 is connected to the capacitor 36 which, in turn, is electrically connected with the first frame 16 of the first electrical device 12. In various examples, the hollow insulating body 38 of the capacitor 36 may include a first interdigitated plated conductive electrode (not shown) that facilitates electrical connection between the first conductive plate 46 and the second end of the conducting shield layer 32. The hollow insulating body 38 of the capacitor 36 may also include a second interdigitated plated conductive electrode (not shown) that facilitates electrical connection between the second conductive plate 48 and the first connector shell 26. Furthermore, the capacitor 36 may be assembled with the elongated conducting core 30, the first connector shell 26 and the conducting shield layer 32 by the shrink tubing process.

The capacitor 36 of the cable 10 substantially reduces electromagnetic interferences caused due to the EMI radiations and the potential difference between the first frame 16 and the second frame 18. As described above, the circuits 44, 56 of the capacitor 36 selectively allow flow of electric current through the conducting shield layer 32 in order to substantially reduce electromagnetic interferences caused due to the EMI radiations and the potential difference between the first frame 16 and the second frame 18. As such, the capacitor 36 can be used to limit electromagnetic interferences in a wide frequency band of the EMI radiations and the potential differences based on a capacitance of the capacitor 36. For example, a capacitance of the capacitor 36 may be increased by adding more number of turns of the circuit 44, 56 around the hollow insulating body 38 in case of low frequencies applications. Additionally, the capacitance of the capacitor 36 may also be increased by increasing the length ‘L’ of the hollow insulating body 38 and the width ‘W’ of the circuit 44, 56 of the cable 10 in case of high frequencies applications. In another example, the capacitance of the capacitor 36 may be increased by increasing number of the surface mounted capacitor units 66. Alternatively or additionally, the capacitance of the capacitor 36 may be increased by increasing a capacitance value of each of the surface mounted capacitor units 66. In particular, the capacitor 36 presents high impedance, based on the capacitance thereof, to induced electric currents at low frequencies.

The cable 10 of the present disclosure may be easily connected with the first electrical device 12 and the second electrical device 14 without requiring any structural modifications in the first electrical device 12 and the second electrical device 14. The capacitor 36 may also be coupled with the conducting shield layer 32 at any intermediate location within the conducting shield layer 32. Moreover, the capacitor 36 may be coupled with the conducting shield layer 32 and the first connector shell 26 by various methods, such as crimping and soldering, thereby eliminating the need of any structural modifications in the first electrical device 12 and the second electrical device 14.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A cable for transmitting electrical signals, the cable comprising:
an elongated conducting core adapted to transmit electrical signals therethrough;
a conducting shield layer disposed around the elongated conducting core, the conducting shield layer having a first end and a second end, wherein the first end is adapted to be electrically coupled with a first frame of a first electrical device, and the second end is adapted to be electrically coupled with a second frame of a second electrical device; and
a capacitor electrically coupled with the conducting shield layer, the capacitor including:
a hollow insulating body having an inner surface and an outer surface, wherein the hollow insulating body receives the elongated conducting core therethrough; and
a circuit disposed around the outer surface of the hollow insulating body, the circuit includes a first conductive plate, a second conductive plate, and a dielectric material sheet disposed between the first conductive plate and the second conductive plate,
wherein at least one of the first conductive plate and the second conductive plate is electrically coupled to the conducting shield layer, and
wherein the circuit is adapted to selectively allow flow of electric current therethrough based on a frequency of electrical and electromagnetic radiations.
